(19) United States
(12) Patent Application Publication
(10) Pub. No.: US 2004/0254975 A1
(43) Pub. Date: Dec. 16, 2004

(54) Method for managing applications and data in a limited capabilities environment via remote virtual hosting and management

(76) Inventors: Jin Teik Teh, Los Altos, CA (US); Ling Wang, Union City, CA (US)

Correspondence Address: Supreme Patent Services, Post Office Box 2339, Saratoga, CA, 95070-0339, US

(21) Appl. No.: 10/461,130

(22) Filed: Jun. 14, 2003

(51) Int. Cl. G06F 15/16

(52) U.S. Cl. 709/200

(57) ABSTRACT

A method for managing applications and data in a limited capabilities environment via remote virtual hosting and management is disclosed in this invention. The method comprises a virtual data management to manage the accessing of applications and data between the platform server and platform client. The present invention uses a least-recently-used algorithm to implement a process to determine which applications can be removed when there is insufficient storage on the platform client. This process allows the users to own and have access to many applications without having to consciously uninstall or reinstall applications whenever they run low on memory or storage space. This also allows a user to have access to more than hundreds of applications and related data when normally a portable device can only hold up only tens of applications and data within the storage capacity.

### FIELD OF THE INVENTION

This invention relates to a method for data communication in a data accessing system, and more specially to a method for data management via remote virtual hosting in a data accessing system.

### BACKGROUND OF THE INVENTION

The wireless Internet is heralded as the next generation of the technology revolution, even though the industry is considered to be in its infancy. On the access front, WAP protocol was not designed for rich media and highly interactive contents; while Java falls short on its “Write once, run everywhere” promise. Neither appears to be the right approach in the wireless arena. On the other hand, several operating systems were proposed for the wireless operating systems, such as, WinPc, Palm, and many other utilities that are forcing software developers with limited sources to make difficult platform choices. The quest for a software platform that is able to deliver rich interactive, device-independent information and applications is still in progress.

Use portable wireless devices as an example. In spite of the limited storage capabilities, users of wireless portable devices usually want to be able to carry their data with them or have access to their data wherever they go. The lack of memory required for information storage remains one of the main obstacles to the materialization of a seamless, integrated data accessing platform. Among them, the first issue to be addressed is a mechanism for allowing users to access their data and applications without being conscious of their device's storage limitation.

### SUMMARY OF THE INVENTION

The present invention, a software platform consists of a set of computer programs that reside on a remote computing facility, called the platform server, and a client program that resides on a portable device, called the platform client. The platform server manages all applications and data belonging to users. On the other hand, the platform client manages the current applications and data that reside on the user's portable device.

The present invention provides a technical solution that could be used in a data accessing platform, from which various data or files containing sufficiently large amount of information can be interactively retrieved by the users within the storage capability of the platform client. That is, when the user demands to access more applications than the device can hold, the platform server and platform client allow applications and data to be swapped automatically in and out of the user's portable device to make room for the demands.

A similar technique, call virtual memory management, is used in conventional memory management to alleviate the users from the burden of explicit memory management. The present invention, adopting a similar philosophy, increases the granularity from memory locations (e.g., bytes in a memory management system) to applications and data files. The present invention also extends the access within a computer to access cross a network of computer systems. In other words, the present invention provides a method of swapping in and out entire applications and documents. This allows the user to “own” and have access to many applications and their related documents without consciously having to uninstall or reinstall applications whenever they run low on memory or storage space. This invention allows users to automatically add and remove applications and the associated without the user having to do it. This allows a user to have access to hundreds of applications and related data when normally his device can only hold up to 10 applications with their data.

The present invention will become more obvious from the following description when taken in connection with the accompanying drawings which show, for purpose of illustration only, a preferred embodiment in accordance with the present invention.

### BRIEF DESCRIPTION OF THE DRAWING

The foregoing aspects and many of the attendant advantages of this invention will become more readily appreciated as the same becomes better understood by reference to the following detailed description, when taken in conjunction with the accompanying drawings, wherein:

FIG. 1 depicts a diagram showing a data management system between a platform server and a platform client.

### DETAILED DESCRIPTION OF THE INVENTION

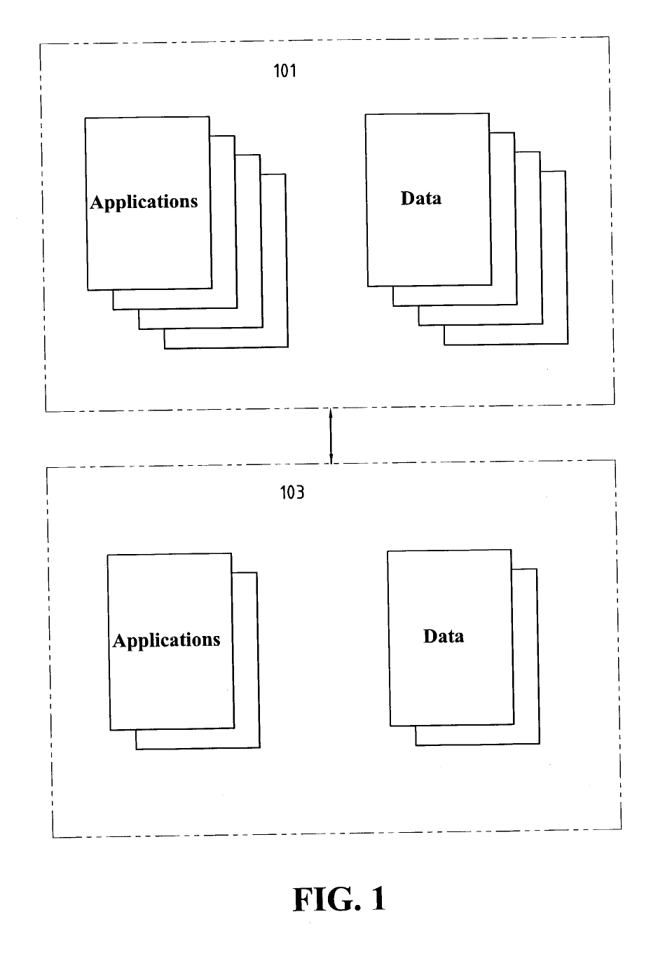

FIG. 1 shows a data accessing system that the present invention can be used in. The system comprises a platform server 101 and a platform client 103. At any given moment, the platform client 103 contains a complete list of the applications stored on the platform server 101, and a partial view into the list of applications and data stored on the said platform server 101. The partial view on the platform client 103 is transmitted from the platform server 101 by either wired or wireless communication technology. When a user accesses an application 105, the platform client 103 determines if the application already exists on platform client 103. If the application is not on the platform client 103, the platform server 101 retrieves the application information from the platform server 101. Then the platform client 103 determines if there is sufficient storage capacity on the platform client 103. If there is, the requested application and data are transmitted to the platform client. Otherwise, some existing applications are removed using a suitable algorithm to make room for the newly requested application and data. The current data belonging to applications to be removed are then first synchronized to the platform server 101 before their removal. After the application and data are removed from the platform client 103 and there is sufficient storage space, the platform server 101 retrieves the requested application and associated data and loads them to the platform client 103. The application retrieved from the platform server 101 must also contain the size, in terms of storage space, of the application and the associated data.

It must be pointed out that the determination of storage space and which applications to be removed, and the actual swapping are performed transparently to the user. That is, a user, on requesting a new application, will initiate such a decision process without explicit instruction. This process allows the users to own and have access to many applications without having to consciously uninstall or reinstall applications whenever they run low on memory or storage space. This also allows a user to have access to more than hundreds of applications and related data when normally a portable device can only hold up only 10 applications and data within the storage capacity.

A preferred embodiment of the present invention employs a least-recently-used algorithm to implement the process for determining which applications and data to be removed. With each application being time-stamped, the least-recently-used algorithm is able to determine which applications are least-recently-used by comparing their time-stamps. The applications with earliest time-stamps are marked for removal one by one when more storage space is needed. When an application is used by the user, its time-stamp is updated to reflect the recent usage.

The application data is also time-stamped in the same way. It is time-stamped at the file or other discrete level. For example, an e-Book application can time-stamp each individual e-Book, so that the least-recently-used e-Books are eligible for removal. As applications are common to all users, there is no need to synchronize the applications before removing them from the platform client. Application data, on the other hand, belong to each individual user. Therefore, prior to removing application data, the application data must be synchronized to platform server 101 and are hosted in the user area. Both applications and application data are hosted at the platform server.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modification and similar structure.

What is claimed is:

1. In a data accessing system having a platform server and a platform client in a remote distance and said platform client accessing applications and data hosted on said platform server, a method for managing the applications and the data in a limited environment via remote virtual hosting and management, said method comprising:
retrieving said application and said date from said platform server;
checking the storage capacity of said platform client;
removing applications and data from said platform client when necessary; and
updating said application and said data to said platform client.

2. The method as in claim 1, wherein said updating said applications and said data to said platform client step can use either wired or wireless technology to transmit data.

3. The method as in claim 1, wherein an algorithm is used to determine which applications for removal.

4. An algorithm as in claim 3, wherein said algorithm uses a time-stamp to mark on said application and said data.

5. An algorithm as in claim 3, wherein said algorithm updates time-stamps when said application or data being used.

6. An algorithm as in claim 3, wherein said algorithm selects said application and said data for removal based on the comparison of said time-stamps.

7. An apparatus used in a data accessing system having a platform server and a platform client in a remote distance, and said platform client accessing applications and data hosted on said platform server, said apparatus comprising:
a first memory storing time stamp indicating the last time said application and data being used,
a second memory storing a program, and
a processor responsive to the said program to:
(1). retrieving said application and said date from said platform server;
(2). checking the storage capacity of said platform client;
(3) removing applications and data from said platform client when necessary; and
(3). updating said application and said data to said platform client.

8. The apparatus as in claim 7, wherein said program can use either wired or wireless technology to transmit updated said applications and said data to said platform client.

9. The apparatus as in claim 7, wherein said removing application and data from said platform client step uses an algorithm to determine which applications for removal.

10. The algorithm as in claim 9, wherein said algorithm uses a time-stamp to mark on said application and said data.

11. The algorithm as in claim 9, wherein said algorithm updates time-stamps when said application or data being used.

12. The algorithm as in claim 9, wherein said algorithm selects said application and said for removal based on the comparison of said time-stamps.

13. An application client service device comprising an apparatus, said apparatus further comprising:
a first memory storing time stamp indicating the last time an application and data on said application client being used,
a second memory storing a program, and
a processor responsive to the said program to:
(1). retrieving said application and said date from an platform server;
(2). checking the storage capacity of said platform client;
(3). removing application and data from said platform client when necessary; and
(3). updating said application and said data to said platform client.

14. An application client service device as in claim 3, wherein said program can use either wired or wireless technology to transmit updated said application and said data to said platform client.

15. An application client service device as in claim 13, wherein said first memory and said second memory is a hard disk.
